(19) United States
(12) Patent Application Publication
(10) Pub. No.: US 2006/0256062 A1
(43) Pub. Date: Nov. 16, 2006

(54) Display device

(76) Inventor: Hirokazu Seki, Tokyo (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(21) Appl. No.: 11/418,299

(22) Filed: May 5, 2006

(30) Foreign Application Priority Data
May 11, 2005 (JP) 2005-138623

(51) Int. Cl. G09G 3/36

(52) U.S. Cl. 345/98

(57) ABSTRACT

A display device includes a display panel having a plurality of pixels, a source driver which drives the pixels according to pixel data items, and a controller which controls the source driver while providing the pixel data items in units of a preset number of items to be transferred in parallel via a differential signal bus group to the source driver. The controller controls is configured to confirm that no discrepancy is present between the preset number of pixel data items, output one of the preset number of pixel data items to a specified differential signal bus of the differential signal bus group, and control the source driver such that the pixel data item from the specified differential signal bus is commonly distributed to corresponding pixels, the number of which equals to the preset number.

### CROSS-REFERENCE TO RELATED APPLICATIONS

This application is based upon and claims the benefit of priority from prior Japanese Patent Application No. 2005-138623, filed May 11, 2005, the entire contents of which are incorporated herein by reference.

### BACKGROUND OF THE INVENTION

1. Field of the Invention

This invention relates to a display device which displays an image corresponding to a digital image signal.

2. Description of the Related Art

A flat-panel display device represented by a liquid crystal display device is widely used as a display device for a personal computer, information mobile terminal, television receiver, car-navigation system and the like.

A general liquid crystal display device includes a display panel having a matrix array of liquid crystal pixels, a drive circuit which drives the liquid crystal pixels, and a control circuit which controls the drive circuit. Generally, the display panel has the structure in which a liquid crystal layer is held between an array substrate and a counter substrate. The array substrate has pixel electrodes arranged in a matrix form and the counter substrate has a common electrode facing the pixel electrodes. The pixel electrode and common electrode form a liquid crystal pixel together with the pixel region of the liquid crystal layer located between the above electrodes, and the alignment of liquid crystal molecules in the pixel region is controlled by an electric field between the pixel electrode and the common electrode. The control circuit holds in an internal storage device a digital image signal which is periodically extracted from the video signal supplied from the exterior and is formed of pixel data items held. The control circuit sets an arrangement order and display timing of the pixel data items to be suitable for the display panel, and controls the drive circuit. For example, the drive circuit sequentially selects rows of pixels, performs the digital-to-analog (D/A) conversion process to convert pixel data items for the pixels of a selected row to corresponding pixel voltages and respectively outputs the pixel voltages to the pixel electrodes of the pixels. The pixel voltage is voltage applied to the pixel electrode with the potential of the common electrode used as a reference.

In the drive circuit, for example, a driver IC is provided to convert pixel data items for the pixels of the selected row to corresponding pixel voltages and respectively supply the voltages to the pixel electrodes of the pixels. In this case, the control circuit controls the driver IC by using the digital image signal in association with a horizontal clock signal, horizontal start signal, horizontal strobe signal, polarity signal and the like. In a concrete control example, first, the horizontal start signal is output from the control circuit and then pixel data items for the pixels of a selected row are output from the control circuit together with the horizontal clock signal. For example, the pixel data items are transferred in unit of a predetermined number of items in parallel via a differential signal bus group to the driver IC (for example, refer to Jpn. Pat. Appln. KOKAI Publication No. 2004-325820). In the driver IC, every preset number of pixel data items are fetched in parallel from the differential bus group in synchronism with the horizontal clock signal and stored in a latch circuit. When all the pixel data items for the pixels of the selected row are stored in the latch circuit, the pixel data items are D/A-converted in synchronism with the strobe signal from the control circuit. The polarity signal is used to specify the polarity of each pixel voltage in the D/A conversion process.

In recent years, high precision has been required in the liquid crystal display device for the mobile terminal and the number of pixels per row tends to increase. Since an increase in the number of pixels increases the total number of pixel data items which are transferred via the differential bus group, it is impossible to neglect power consumption for data transfer in the mobile terminal which often uses a battery.

This invention has been made in view of the above problem and an object thereof is to provide a display device which can reduce the power consumption for data transfer.

### BRIEF SUMMARY OF THE INVENTION

According to an aspect of the invention, there is provided a display device which comprises display panel having a plurality of pixels; a drive circuit which drives the pixels according to pixel data items; and a control circuit which controls the drive circuit while providing the pixel data items in units of a preset number of pixel data items to be transferred in parallel via a differential signal bus group to the drive circuit; wherein the control circuit is configured to confirm that no discrepancy is present between the preset number of pixel data items, output one of the preset number of pixel data items to a specified differential signal bus of the differential signal bus group, and control the drive circuit such that the pixel data item from the specified differential signal bus is commonly distributed to corresponding pixels, the number of which equals to the preset number.

In the display device, when no discrepancy is present between the preset number of pixel data items to be transferred in parallel to the drive circuit, the control circuit outputs one of the preset number of pixel data items to a specified differential signal bus of the differential signal bus group, and controls the driver circuit such that the pixel data item from the specified differential signal bus is commonly distributed to corresponding pixels, the number of which equals to the preset number. That is, since it is not necessary to change the potentials of differential signal buses other than the specified differential signal bus, the effective data transfer frequency can be lowered in the other differential signal buses. Therefore, power consumption used for data transfer can be reduced.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate an embodiment of the invention, and together with the general description given above and the detailed description of the embodiment given below, serve to explain the principles of the invention.

FIG. 1 is a diagram schematically showing the circuit configuration of a liquid crystal display device according to one embodiment of this invention;

FIG. 2 is a diagram schematically showing the configuration of a controller and source driver shown in FIG. 1;

FIG. 3 is a diagram showing the configuration of the source driver shown in FIG. 2 more in detail; and

FIG. 4 is a diagram showing 6-bit pixel data transferred for every three bits via a differential signal bus shown in FIG. 3.

### DETAILED DESCRIPTION OF THE INVENTION

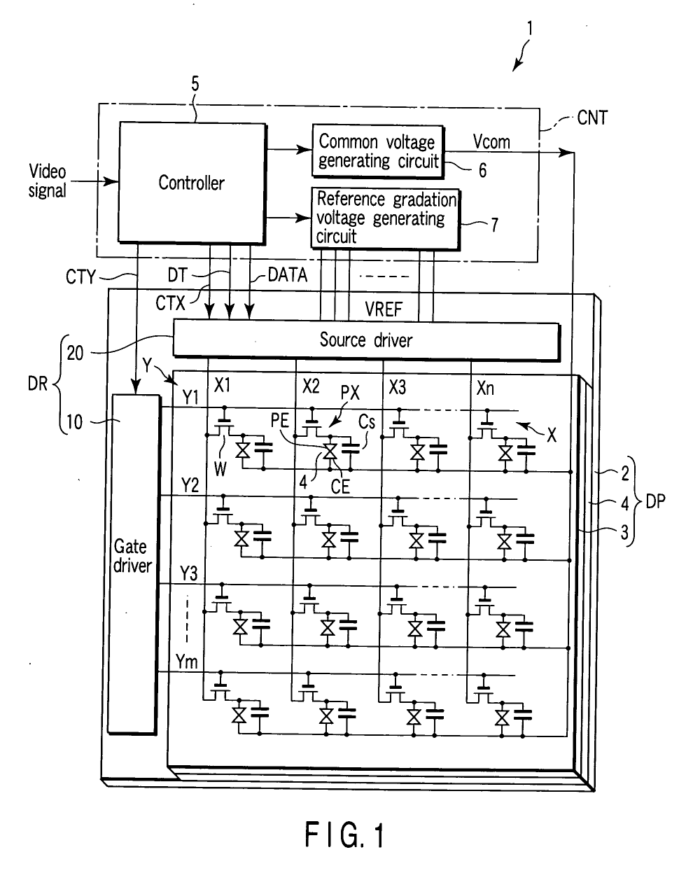

There will now be described a liquid crystal display device according to one embodiment of this invention with reference to the accompanying drawings. FIG. 1 schematically shows the circuit configuration of a liquid crystal display device 1. The liquid crystal display device 1 includes a display panel DP having a plurality of liquid crystal pixels PX, a drive circuit DR which drives the liquid crystal pixels PX and a control circuit CNT which controls the drive circuit DR. The display panel DP has a structure in which a liquid crystal layer 4 is held between an array substrate 2 and a counter substrate 3.

The array substrate 2 has a plurality of pixel electrodes PE arranged in a matrix form on a transparent insulating substrate such as a glass plate, for example, a plurality of gate lines Y (Y1 to Ym) arranged along the rows of pixel electrodes PE, a plurality of source lines X (X1 to Xn) arranged along the columns of pixel electrodes PE, a plurality of pixel switching elements W arranged near the intersections between the gate lines Y and the source lines X, a gate driver 10 which sequentially drives the gate lines Y one for each horizontal display period, and a source driver 20 which drives the source lines X while each gate line Y is being driven. Each pixel switching element W is formed of a poly-silicon thin film transistor, for example. In this case, the gate of the thin film transistor is connected to one gate line Y and the source-drain path thereof is connected between one source line X and one pixel electrode PE. The drive circuit DR includes the gate driver 10 and source driver 20. The gate driver 10 is configured by use of poly-silicon thin film transistors formed in the same process as that of the pixel switching elements W. Further, the source driver 20 is a driver IC chip mounted on the array substrate 2 by the Chip On Glass (COG) technique. However, the gate driver 10 and source driver 20 can be arranged around the display panel DP as Tape Carrier Packages (TCPs).

The counter substrate 3 includes a color filter (not shown) arranged on the transparent insulating substrate such as a glass plate, for example, and a common electrode CE arranged on the color filter and facing the pixel electrodes PE. The color filter includes colored layers of red, green and blue which are formed in strips and repeatedly arranged in the row direction. The pixel electrodes PE and common electrode CE are made of a transparent electrode material such as ITO. Each pair of the pixel electrode PE and common electrode CE forms a liquid crystal pixel PX together with a corresponding pixel region of the liquid crystal layer 4 which is located between the paired electrodes PE and CE. The alignment of liquid crystal molecules in the pixel region is controlled according to an electric field between the paired electrodes PE and CE. Further, all of the pixels PX have storage capacitances Cs. To obtain the storage capacitances Cs, the common electrode CE is electrically connected to storage capacitance lines which are capacitively coupled to the rows of pixel electrodes PE on the array substrate 2 side.

The control circuit CNT holds a digital image signal DATA for the pixels of one row which is extracted for each horizontal scanning period from the video signal supplied from the exterior and is formed of pixel data items, sets an arrangement order and display timing of the pixel data items to be suitable for the display panel, and controls the drive circuit DR. In the control circuit CNT, a controller 5, common voltage generating circuit 6 and reference gradation voltage generating circuit 7 are provided. The controller 5 controls the common voltage generating circuit 6, reference gradation voltage generating circuit 7, gate driver 10 and source driver 20 in order to obtain an image displayed on the display panel DP. The common voltage generating circuit 6 supplies a common voltage Vcom to the common electrode CE on the counter substrate 3. The reference gradation voltage generating circuit 7 generates a preset number of reference gradation voltages VREF used to convert 6-bit pixel data for each pixel PX into pixel voltage, for example.

The controller 5 generates a control signal CTY used to sequentially select the gate lines Y in one vertical scanning period (1 V) and a control signal CTX used to respectively assign pixel data items for pixels PX of a selected row to the source lines X for each horizontal scanning period (1 H) in which each gate line Y is selected. The control signal CTY is supplied from the controller 5 to the gate driver 10 and the control signal CTX is supplied from the controller 5 to the source driver 20 together with the digital image signal DATA. The control signal CTX includes a horizontal start signal STH, horizontal clock signal CKH, horizontal strobe signal STB, polarity signal POL and the like.

The gate driver 10 is controlled by the control signal CTY and sequentially selects the gate lines Y to output a scanning signal, which is supplied to a selected gate line Y and keeps corresponding pixel switching elements W conductive for one horizontal scanning period. The source driver 20 uses the preset number of reference gradation voltages generated from the reference gradation voltage generating circuit 7 to D/A-convert pixel data items for the pixels PX of a selected row into corresponding pixel voltages and supply the thus converted voltages to the source lines X. As a result, the pixel voltages on the source lines X are applied to the pixel electrodes PE of the pixels PX of the selected row via the corresponding pixel switching elements W which are kept conductive by the scanning signal from the selected gate line Y. The voltage is applied to the pixel electrode PE with the potential of the common electrode CE used as a reference and the transmittance of the pixel PX is determined by the potential difference between the pixel electrode PE and the counter electrode CE.

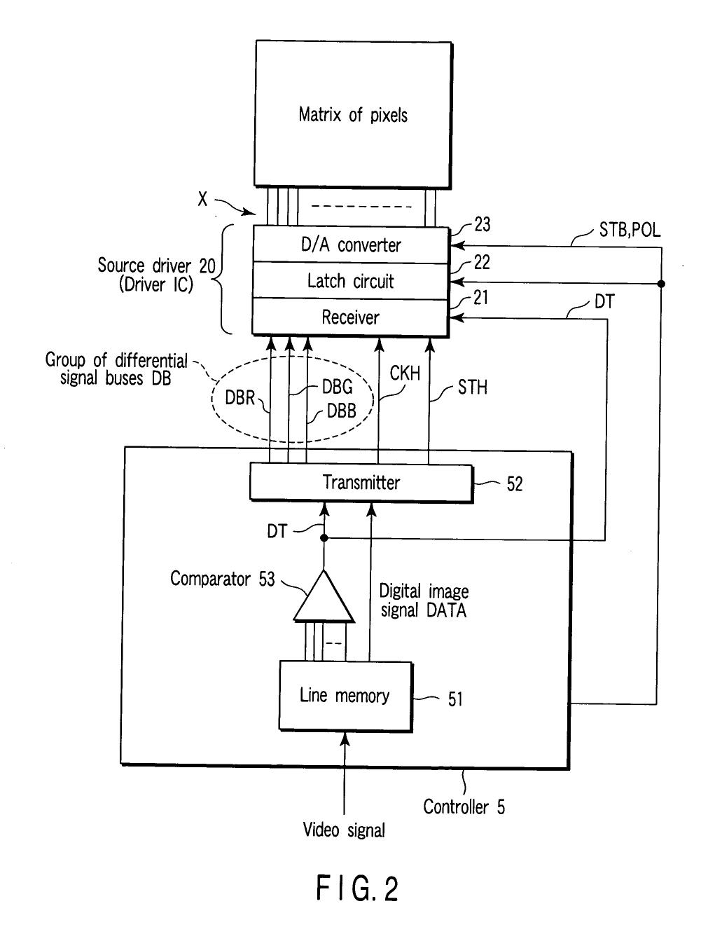

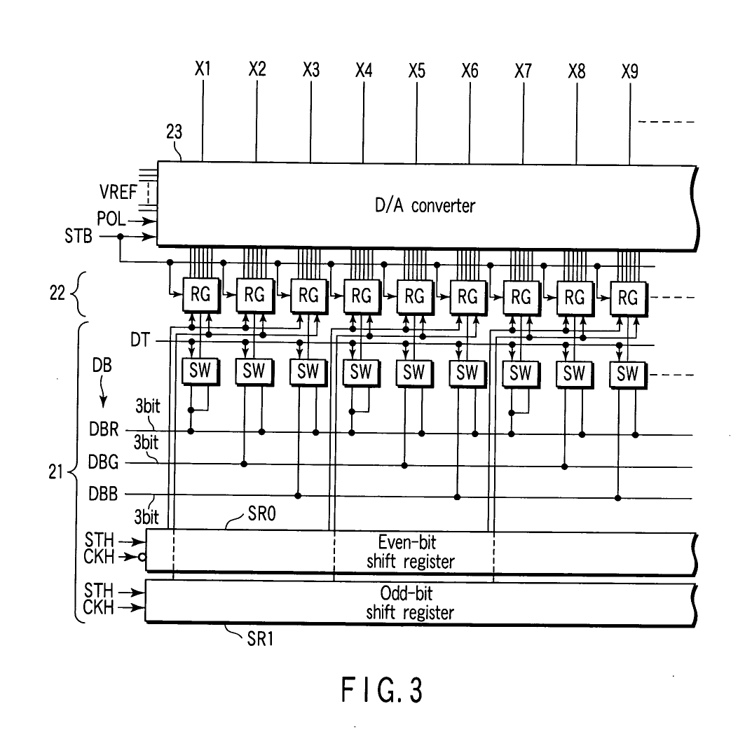

FIG. 2 schematically shows the configuration of the controller 5 and source driver 20 shown in FIG. 1, and FIG. 3 shows the configuration of the source driver shown in FIG. 2 more in detail.

The controller 5 includes a line memory 51 and transmitter 52, and the source driver 20 includes a receiver 21, latch circuit 22 and D/A converter 23. The transmitter 52 and receiver 21 are connected to a difference signal bus group DB. The line memory 51 is an internal storage device which stores a digital image signal DATA for several lines (rows) of pixels. The internal storage device is so configured that the digital image signal DATA for the pixels of one line which is extracted from the video signal can be stored into one area while the digital image signal DATA for the pixels of a preceding line are being retrieved from another area. The transmitter 52 transmits pixel data items which are stored in the line memory 51 as the digital image signal DATA for one line of pixels, to the receiver 21 along with the horizontal start signal STH and horizontal clock signal CKH which are set in conformity with the transmission timing of the pixel data items.

The differential signal bus group DB includes a preset number of differential signal buses, e.g., three differential signal buses DBR, DBG, DBB. The differential signal buses DBR, DBG, DBB are provided to transfer the pixel data items which are output from the transmitter 52 in units of three for red, green and blue pixels. When the pixel data items are of 6 bits, each of the differential signal buses DBR, DBG, DBB contains three pairs of differential signal lines used to transfer the 6-bit pixel data for every three bits. In this case, odd bits and even bits of the pixel data are alternately assigned to the three pair of differential signal lines and the potentials of the differential signal lines of each pair are set in a complementary relation corresponding to the bit value during the data transfer. Specifically, one of the potentials of the differential signal lines is changed to a high level and the other potential is changed to a low level.

The controller 5 further includes a comparator 53 connected to the line memory 51. The comparator 53 receives the preset number of pixel data items which are simultaneously output from the line memory 51 to the transmitter 52 and are to be transferred in parallel from the transmitter 52 to the receiver 21, compares the pixel data items with one another, and outputs a detection signal DT when the pixel data items are the same. The detection signal DT is supplied to the transmitter 52 and receiver 21. At this time, one of the differential signal buses DBR, DBG, DBB, for example, the differential signal bus DBR is used as a specified differential signal bus, the transmitter 52 is controlled to maintain the potential relations of the differential signal buses DBG, DBB other than the specified differential signal bus DBR and the receiver 21 is controlled to fetch the potential relation of the specified differential signal bus DBR as those of the preset number of pixel data items, that is, three pixel data items.

The receiver 21 fetches the pixel data items transferred in units of three items via the differential signal buses DBR, DBG, DBB, and the latch circuit 22 latches three pixel data items each time these pixel data items are fetched together by the receiver 21, and the D/A converter 23 D/A-converts all the pixel data items for the pixels of one row held in the latch circuit 22 to corresponding pixel voltages.

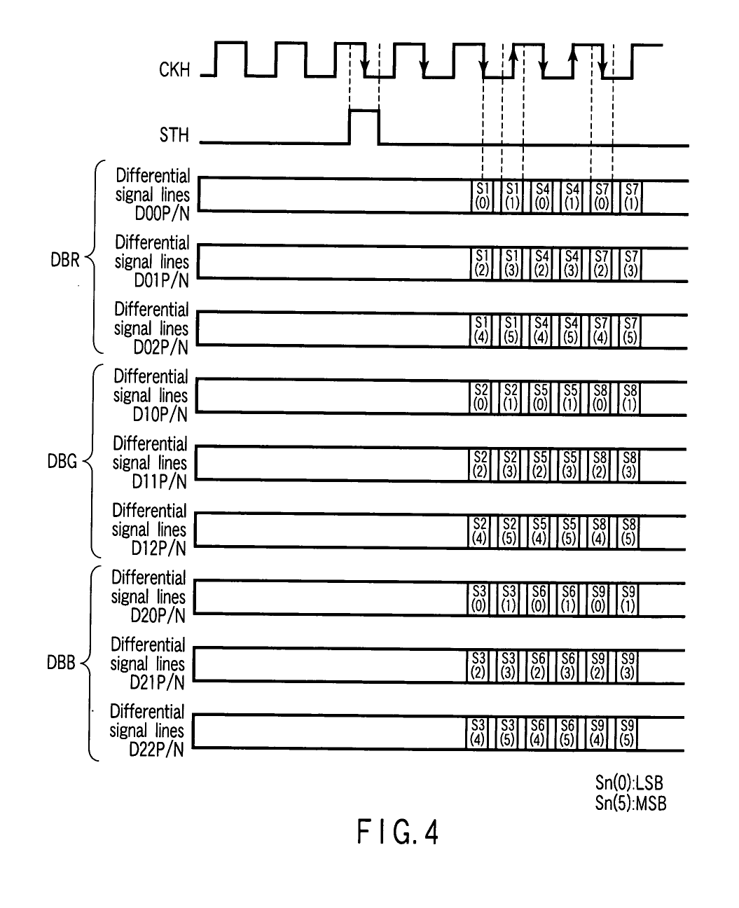

As shown in FIG. 3, the receiver 21 includes an even-bit shift register SR0, odd-bit shift register SR1 and n 3-bit analog switches SW, and the latch circuit 22 includes n 6-bit registers RG. The shift register SR0 has n/3 output terminals, shifts the horizontal start signal STH in response to a fall of the horizontal clock signal CKH and outputs a selection signal from one of the output terminals which is sequentially changed. Likewise, the shift register SR1 has n/3 output terminals, shifts the horizontal start signal STH in response to a rise of the horizontal clock signal CKH and outputs a selection signal from one of the output terminals which is sequentially changed. Every three of the n analog switches SW and n registers RG are assigned to the source lines X1 to X3, X4 to X6, . . . . The differential signal buses DBR, DBG, DBB are connected to the first input terminals of the analog switches SW for the source lines X1 to X3, the first input terminals of the analog switches SW for the source lines X4 to X6, . . . , respectively. Further, the differential signal bus DBR is connected to the second input terminals of all of the n analog switches SW. The output terminals of the analog switches SW for the source lines X1 to X3, the output terminals of the analog switches SW for the source lines X4 to X6, . . . are connected to the input terminals of the registers RG for the source lines X1 to X3, the input terminals of the registers RG for the source lines X4 to X6, . . . , respectively. All of the n analog switches SW perform the switching operation to selectively connect ones of the first and second input terminals to the n registers RG under control of the detection signal DT from the comparator 53. In a case wherein the detection signal DT is not supplied from the comparator 53, the analog switches SW permit three pixel data items S1 to S3, S4 to S6, . . . obtained, as shown in FIG. 4, from the differential signal buses DBR, DBG, DBB to be supplied to the corresponding registers RG, for example. On the other hand, in a case wherein the detection signal DT is supplied from the comparator 53, the analog switches SW permit single pixel data item S1, S4, S7, . . . obtained from the differential signal bus DBR to be distributed to the corresponding registers RG as three pixel data items.

The registers RG for the source lines X1 to X3, the registers RG for the source lines X4 to X6, . . . latch even bits and odd bits of three pixel data items S1 to S3, S4 to S6, S7 to S9, . . . output from the analog switches SW for the source lines X1 to X3, the analog switches SW for the source lines X4 to X6, . . . in response to the selection signal output from the corresponding output terminal of the shift register SR0 and the selection signal output from the corresponding output terminal of the shift register SR1. Thus, with the latch circuit 22, the pixel data items S1 to Sn for the pixels of one row are latched in units of three and held in parallel. The strobe signal STB is supplied from the controller 5 to the D/A converter 23 each time the pixel data items S1 to Sn are held in the latch circuit 22. The D/A converter 23 receives pixel data items S1 to Sn from the latch circuit 22 in synchronism with a rise of the strobe signal STB, D/A-converts the data items to corresponding pixel voltages and outputs the thus converted pixel voltages to the source lines X1 to Xn in synchronism with a fall of the strobe signal STB. The polarity signal POL is a signal inverted for each horizontal scanning period in which the pixels PX of one row are selected by the gate driver 10 and the polarities of the pixel voltages are determined by the polarity signal POL from the controller 5.

In the above liquid crystal display device, the comparator 53 is configured to control the transmitter 52 and the analog switches SW when it is detected that three pixel data items to be transferred in parallel from the transmitter 52 to the receiver 21 are the same. The transmitter 52 is controlled to output one of the three pixel data items to the specified differential signal bus DBR of the differential signal buses DB, and the analog switches SW are controlled to commonly distribute the pixel data item from the specified differential signal bus DBR to three corresponding pixels PX. That is, since it is not necessary to change the potentials of the differential signal buses DBG, DBB other than the specified differential signal bus DBR, the effective data transfer frequency in the other differential signal buses DBG, DBB can be lowered. Therefore, the power consumption for data transfer can be reduced.

This invention is not limited to the above embodiment and can be variously modified without departing from the technical scope thereof.

In the above embodiment, the three differential signal buses DBR, DBG, DBB are provided. When no discrepancy is present between three pixel data items to be transferred in parallel from the transmitter 52 to the receiver 21, one of the three pixel data items is output to the specified differential signal bus DBR, and the pixel data item from the specified differential signal bus DBR is commonly distributed to three corresponding pixels PX. However, the this invention is applicable to the case where an increased number of differential signal buses, for example, six differential signal buses are provided with an increase in the number of pixels. In this case, when no discrepancy is present between six pixel data items to be transferred in parallel from the transmitter 52 to the receiver 21, one of the six pixel data items is output to a specified differential signal bus which is one of the differential signal buses, and the pixel data from the specified differential signal bus is commonly distributed to six corresponding pixels PX.

Further, this invention is also applicable to the case where the six differential signal buses are divided into two groups and two comparators 53 are respectively provided for the two groups of differential signal buses. In this case, when no discrepancy is present between three pixel data items to be transferred in parallel from the transmitter 52 to the receiver 21 via the first group of differential signal buses, the first comparator 53 is configured to perform a control by which one of the three pixel data items is output to a specified differential signal bus which is one of the differential signal buses of the first group, and the pixel data item from the specified differential signal bus is commonly distributed to three corresponding pixels PX. Further, when no discrepancy is present between three pixel data items to be transferred in parallel from the transmitter 52 to the receiver 21 via the second group of differential signal buses, the second comparator 53 is configured to perform a control by which one of the three pixel data items is output to a specified differential signal bus which is one of the differential signal buses of the second group, and the pixel data item from the specified differential signal bus is commonly distributed to three corresponding pixels PX.

This invention is applicable not only to a liquid crystal display device in which pixel data items forming digital image data are transferred in units of a predetermined number of items from the controller 5 to the source driver 20 via the differential signal bus group DB, but to another display device, for example, an organic electroluminescent display device which is configured to transfer data in the same manner as described above.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A display device comprising:
a display panel having a plurality of pixels;
a drive circuit which drives the pixels according to pixel data items; and
a control circuit which controls the drive circuit while providing the pixel data items in units of a preset number of items to be transferred in parallel via a differential signal bus group to the drive circuit;
wherein the control circuit is configured to confirm that no discrepancy is present between the preset number of pixel data items, output one of the preset number of pixel data items to a specified differential signal bus of the differential signal bus group, and control the drive circuit such that the pixel data item from the specified differential signal bus is commonly distributed to corresponding pixels, the number of which equals to the preset number.

2. The display device according to claim 1, wherein the control circuit includes a transmitter which outputs the preset number of pixel data items to the differential signal bus group, the drive circuit includes a receiver which fetches the preset number of pixel data items from the differential signal bus group and a latch circuit which latches the preset number of pixel data items fetched by the receiver, and the control circuit further includes a comparator which compares the preset number of pixel data items with one another to generate a detection signal that controls the transmitter to maintain a potential relation of the differential signal buses other than the specified differential signal bus and controls the receiver to fetch a potential relation of the specified differential signal bus as the preset number of pixel data items, when the compared pixel data items are the same.

3. The display device according to claim 2, wherein the latch circuit includes a register portion which is connected to the differential signal bus group and stores the preset number of pixel data items and the receiver includes a switch portion which changes connections of all registers of the register portion to the specified differential signal bus in response to the detection signal.

4. The display device according to claim 2, wherein the plurality of pixels are arranged in a matrix form, the drive circuit includes a driver IC which drives a plurality of source lines provided for respective columns of the pixels and the receiver is incorporated into the driver IC.

5. The display device according to claim 1, wherein the plurality of pixels are liquid crystal pixels.
